(19) United States
(12) Patent Application Publication
(10) Pub. No.: US 2005/0270973 A1
(43) Pub. Date: Dec. 8, 2005

(54) Cluster architecture communications

(76) Inventors: Kaloyan V. Raev, Sofia (BG); Jochen Mueller, Heidelberg (DE); Jasen O. Minov, Sofia (BG); Georgi Stanev, Sofia (BG); Petio G. Petev, Sofia (BG)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/863,123

(22) Filed: Jun. 7, 2004

(51) Int. Cl. H04L 1/00

(52) U.S. Cl. 370/218

(57) ABSTRACT

A cluster includes a plurality of application server instances, a central services instance that includes a message server, and a database. The application server instances each include a dispatcher, a plurality of redundant server nodes, and a socket connection between the dispatcher and each of the server nodes for handling communications relating to processing a client request. A separate socket connection between the message server and each of the server nodes is provided for handling internal communications between the server nodes. Additionally, a third socket connection may be established directly between server nodes.

### TECHNICAL FIELD

Embodiments of the invention generally relate to the field of data processing systems. More particularly, the invention relates to a cluster architecture for data processing systems.

### BACKGROUND

In prior art cluster architectures, session communications and internal communications, for example, server-to-server communications, were handled over the same socket connection. Peer-to-peer connections between all the nodes in the cluster additionally resulted in a complicated network configuration that did not scale well in terms of network resources, communication bandwidth and overhead, and lead to limited multicast and/or broadcast communication capabilities.

### SUMMARY OF THE INVENTION

Embodiments of the invention are generally directed to a cluster architecture, and in particular separate communication facilities for internal cluster communications versus external, client request driven communications. The invention allows for separate and parallel communications between dispatcher nodes and server nodes, and among server nodes, either via a message server or a direct socket connection between servers nodes, even those in different application server instances.

### BRIEF DESCRIPTION OF THE DRAWINGS

Embodiments of the invention are illustrated by way of example, and not by way of limitation, in the figure of the accompanying drawing:

FIG. 1 is a block diagram of an embodiment of the invention.

### DETAILED DESCRIPTION

Embodiments of the invention are generally directed to communication facilities and methods among components of a cluster architecture.

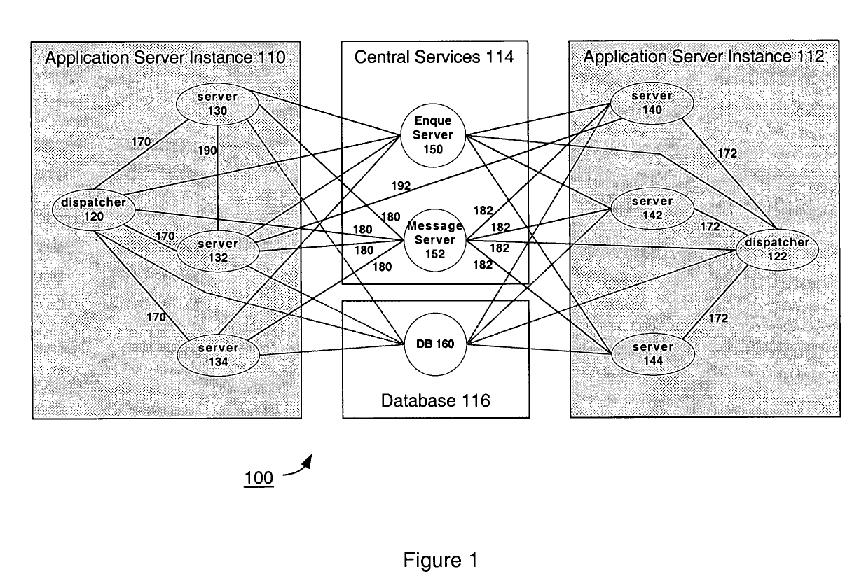

FIG. 1 is a block diagram of an application server cluster architecture 100 employed in one embodiment of the invention. The architecture includes a central services instance 114 and a plurality of application server instances 110, 112. Each application server instance is a unit in the cluster that can be started, stopped and monitored separately. In one embodiment, each instance runs on a physical server, but more than one instance may run on a single physical server. In one embodiment, a system identification number and an instance number identify an instance within the cluster.

An instance typically contains at least one server process, or “application server node”. More commonly, an instance includes a dispatcher and several server nodes. It is also contemplated that more than one dispatcher may reside in a single instance. In FIG. 1, application server instances 110 and 112 each include a group of application server nodes 130, 132, 134, and 140, 142 and 144, respectively, and a dispatcher, 120, 122, respectively. Each application server node and each dispatcher is resident in a virtual machine. In one embodiment, the VM may be a Java Virtual Machine (JVM). Central services instance 114 includes locking service provided by enqueue server 150 and a messaging service provided by message server 152 (described below). The combination of all of the application server instances 110, 112 and central services instance 114 is referred to herein as a cluster 100.

Application server nodes 130, 132 and 134 within application server instance 110 provide the business and/or presentation logic for the applications supported by the system. Each application server node provides a set of core services to the business and/or presentation logic. Likewise, application server nodes 140, 142 and 144 provide support for applications running on application server instance 112.

Each of the application server nodes within a particular instance may be configured with a redundant set of application logic and associated data. In one embodiment, a dispatcher 120 distributes service requests from clients to one or more of server nodes 130, 132 and 134, based, for example, on the load on each of the servers. For example, in one embodiment, a dispatcher implements a round-robin policy of distributing service requests (although various alternate load-balancing techniques may be employed). Application server instances receive requests from one or more clients, for example, via a web client, over a distributed network such as the Internet. In one embodiment, requests from the web client may be transmitted using hypertext transfer protocol (HTTP), HTTPS, SMTP, or SOAP.

In one embodiment of the invention, server nodes 130, 132, 134, 140, 142 and 144 are Java 2 Platform, Enterprise Edition (“J2EE”) server nodes that support Enterprise Java Bean (“EJB”) components and EJB containers (at the business layer) and Servlets and Java Server Pages (“JSP”) (at the presentation layer). A J2EE platform complies with the J2EE Standard. Of course, certain aspects of the embodiment of the invention described herein may be implemented in the context of other software platforms including, by way of example, Microsoft .NET platforms and/or the Advanced Business Application Programming (“ABAP”) platforms developed by SAP AG, the assignee of the this patent application.

Message server 152 is responsible for intra- as well as inter-instance communication. For example, if a server node 130 of instance 110 wishes to send an internal message to instance 112, a message is sent via the message server 152. In one embodiment, each server node and each dispatcher node has a link 180, 182 through which it can communicate with the message server, and through which the message server may send messages notifying of events within the cluster. Message server 152 also supplies a dispatcher 120, 122 with information to facilitate load balancing between various instances in the cluster. The message server 152 also provides notification of events that arise within a cluster, for example, failure or shutdown of an instance or when a service is started or stopped. Because the message server may represent a single point of failure in the cluster, it should support failover to be effectively used in high availability systems. To that end, in one embodiment, the message server has no persistent state such that if the message server fails, it need merely be restarted and then re-register instances in the cluster without performing any state recovery procedures.

In one embodiment, communication and synchronization between each of instances 110 and 112 is enabled via central services instance 114, in particular, by the messaging service provided by message server 152. The message service allows each of the server nodes within each of the instances to communicate with one another via a message passing protocol. For example, messages from one server node may be broadcast to all other server nodes within the cluster via the messaging service. In addition, messages may be addressed directly to specific server nodes within the cluster (e.g., rather than being broadcast to some number or all of the server nodes).

The cluster in FIG. 1 separates communications relating to external client requests and responses from internal communications relating to the operation of the cluster. Client requests and responses, herein referred to as “session” communications, involve an exchange of messages between a dispatcher and a server in connection with processing a client request or response thereto. An HTTP request from an external web client such as a web browser application is an example of a session communication. Internal communications, on the other hand, relate to information about events in the cluster, and involve an exchange of messages between server nodes in the cluster. For example, internal communications may be exchanged between server nodes to update state information in the cluster. Cluster state changes upon the occurrence of such events as the addition of a new server node to the cluster, the loss or unavailability of an existing server node, a change in state of a server node, or a change in the ability or availability of a server node to communicate with other nodes in the cluster. Session communications are separated from internal communications through the use of separate socket connections.

Sockets are the mechanisms that allow the elements of the cluster to communicate, either on the same machine or across a network. Each physical server in the cluster is identified by some address. In a TCP/IP networking environment, the network address is IP address. Apart from the IP address that specifies a machine, each machine has a number of ports, for example, TCP ports, that allows handling multiple socket connections simultaneously.

A program that wants to accept a socket connection with another program creates a socket, binds the socket to a specific address, e.g., an IP address, and port, and then listens for requests on the socket to establish a connection. An application server node creates a server socket and listens on it to accept socket connections from the dispatcher node and other server nodes. In one embodiment, a socket connection between a server node and the message server is initiated by the server node to a server socket on the message server created by the message server.

With reference to FIG. 1, each dispatcher and server node has a socket connection with message server 152 via respective links 180, 182. Internal communications between servers, and between the dispatcher and message server, are transmitted over such socket connections. Contemporaneously, each dispatcher maintains a separate socket connection with server nodes in the same application server instance via respective links 170, 172. Session communications between dispatcher and server nodes are transmitted over such socket connections. In one embodiment, the socket connections between dispatcher and server nodes are limited to only those server nodes in the same application server instance in which the dispatcher resides, thereby providing for the ability to physically limit communications between dispatchers and server nodes to the same physical server node.

Thus, each server node has at least two socket connections—one with the dispatcher over which to transmit session communications and one with the message server over which to transmit internal communications. A dispatcher maintains two types of socket connections—a first socket connection between the dispatcher and message server for exchanging internal communications, and multiple instances of a second socket connection, duplicated between the dispatcher and each server node to which it is distributing client requests, for exchanging session communications.

In the case of a session communication between a dispatcher and server node, if the socket connection providing such communication breaks, the dispatcher attempts to reinitialize the session communication with the server node. In one embodiment, the server node may send a notification to the message server via its socket connection with the message server for internal communication, the notification providing state information that the server node is unavailable, or down. The dispatcher, before attempting to reinitialize the session communication with the server node, may receive such indication from the message server via its socket connection with the message server, or may poll the message server for the state of the server node. If the dispatcher thereby determines the server node is unavailable, it does not attempt to reinitialize the socket connection for session communications with the server node.

The message server, in one embodiment of the invention, sends a notification or acknowledgement message in response to each message it receives from a server node or a dispatcher. If the message server goes down or otherwise becomes unavailable, a server node that does not receive such an acknowledgement can attempt to retransmit its message to the message server, or wait until it receives an indication that the message server is up and operating again. The message server, upon becoming available, can indicate such in a message, for example, a multicast or broadcast message, sent over the socket connection for internal communications between the message server and each of the server nodes in the cluster.

In one embodiment of the invention, the message server is single threaded, and can become overloaded by messages, creating a bottleneck. To ease message congestion at the message server, a third and different socket connection may be established directly between two server nodes, bypassing the respective socket connections between the server nodes and the message server. For example, server node 130 can establish a socket connection 190 with server node 132 in the same application server instance, for direct intra-instance exchange of internal communications. In addition, a server node can establish a socket connection with a server node in a separate application server instance for direct inter-instance exchange of internal communications. For example, server node 132 in application server instance 110 can establish a socket connection 192 with server node 140 in application server instance 112, for direct exchange of internal communications, thereby bypassing socket connections between server node 132 and message server 152 and between server node 140 and message server 152.

This third socket connection provides an alternative way for exchanging internal communications between server nodes. A server node can initiate opening of this additional socket connection directly to another server node if, for example, data transfer rates over the internal communications socket connection via the message server meet or exceed a threshold. Likewise, a server node can initiate tearing down the direct socket connection to another server node if, for example, the data transfer rate over one or both of the contemporaneous socket connections to the other server node by way of the message server fall below a certain threshold for some minimum amount of time.

The order of internal messages sent between two server nodes is maintained, even in the event that a separate socket connection is contemporaneously established directly between the two server nodes. This can be accomplished through the use of a single output queue per service on a server node, so whether a message is transmitted from one server node to another via socket connections with the message server, or via the direct socket connection between the server nodes, the message arrives in the same order with respect to other messages in the output queue.

Transmitting multicasting messages among server nodes is accomplished via socket connections for internal communications between each server node and the message server. A server node need only send one multicast message to the message server. The message server replicates the message and transmits it to each destination server node over its respective socket connection with the message server.

Elements of embodiments of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of embodiments of the invention, various features are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed subject matter requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

1. A system comprising:
a message server;
a plurality of application server instances, each application server instance having a dispatcher, a plurality of redundant server nodes, and a socket connection between the dispatcher and each of the server nodes for handling communications relating to processing a client request, and
a separate socket connection between the message server and each of the server nodes for handling internal communications between the server nodes.

2. The system of claim 1, further comprising the separate socket connection between the message server and each of the dispatchers for handling internal communications between the dispatchers and the server nodes.

3. The system of claim 1, wherein internal communications between the server nodes includes communications indicating one or more of: a change in state in the system, an addition of a server node to the system, a loss or removal of a server node from the system, a change in state of a server node, a change in state of services provided by a server node, and a change in state of a server node to communicate with other server nodes in the system.

4. The system of claim 3, wherein internal communications between the server nodes includes communications between server nodes in separate application server instances.

5. The system of claim 1, wherein each application server instance runs on a physical server.

6. The system of claim 4, wherein multiple application server instances run on the same physical server.

7. The system of claim 2, wherein the dispatcher provides for opening a new socket connection between the dispatcher and a respective server node if the socket connection between the dispatcher and the server node fails, unless the message server provides for sending an internal communications message over the separate socket connection between the message server and the dispatcher that a new socket connection cannot be opened to the server node.

8. The system of claim 1, further comprising a third socket connection directly between two of the server nodes.

9. The system of claim 8, wherein the third socket connection directly between two of the server nodes provides for handling internal communications between the two server nodes instead of via the separate socket connections between each of the two server nodes and the message server.

10. The system of claim 9, wherein the third socket connection provides for handling internal communications between the two server nodes if such communication is or would become prohibited via the separate socket connections between each of the two server nodes and the message server.

11. The system of claim 10, wherein such communication is or would become prohibited depending on a data transfer rate threshold.

12. The system of claim 11, wherein the third socket connection is established when the data transfer rate would be exceeded by such communications.

13. The system of claim 12, wherein the third socket connection is terminated in favor of internal communications via the separate socket connections between each of the two server nodes and the message server after the data transfer rate is no longer exceeded.

14. The system of claim 8, wherein each of the two server nodes resides in a different application server instance.

15. The system of claim 8, wherein each of the two server nodes resides in a different Java 2 Enterprise Edition (J2EE) application server instance.

16. The system of claim 1, wherein the system provides for one of the server nodes to transmit an internal communications message to the message server via the separate socket connection between the server node and the message server, and the message server to replicate and transmit the message to the other server nodes via the respective separate socket connections between the message server and the other server nodes.

17. The system of claim 16, wherein the message server provides for sending an acknowledgement message over the separate socket connection to a server node in response to a message received from the server node over the separate socket connection.

18. The system of claim 17, wherein upon failure of the message server to send the acknowledgement message to the server node, the server node provides for resending the message.

19. The system of claim 18, wherein the server node provides for resending the message after receiving an indication from the message server that the message server can receive messages.

20. A article of manufacture, comprising: an electronically accessible medium providing instructions that, when executed by an apparatus, cause the apparatus to implement:
a message server;
a plurality of application server instances, each application server instance having a dispatcher, a plurality of redundant server nodes, and a socket connection between the dispatcher and each of the server nodes for handling communications relating to processing a client request, and
a separate socket connection between the message server and each of the server nodes for handling internal communications between the server nodes.

21. The article of manufacture of claim 20, wherein the electronically accessible medium further comprises instructions that, when executed by the apparatus, cause the apparatus to implement a separate socket connection between the message server and each of the dispatchers for handling internal communications between the dispatchers and the server nodes.

22. The article of manufacture of claim 20, wherein the electronically accessible medium comprises instructions that, when executed by an apparatus, cause the apparatus to implement internal communications between server nodes in separate application server instances.

23. The article of manufacture of claim 21, wherein the electronically accessible medium comprises instructions that, when executed by an apparatus, cause the dispatcher to open a new socket connection between the dispatcher and a respective server node if the socket connection between the dispatcher and the server node fails, unless the message server provides for sending an internal communications message over the separate socket connection between the message server and the dispatcher that a new socket connection cannot be opened to the server node.

24. The article of manufacture of claim 20, wherein the electronically accessible medium comprises instructions that, when executed by an apparatus, cause the apparatus to implement a third socket connection directly between two of the server nodes.

25. The system of claim 24, wherein the third socket connection directly between two of the server nodes provides for handling internal communications between the two server nodes instead of via the separate socket connections between each of the two server nodes and the message server.

26. The system of claim 25, wherein the third socket connection provides for handling internal communications between the two server nodes if such communication is or would become prohibited via the separate socket connections between each of the two server nodes and the message server.

27. The article of manufacture of claim 20, wherein the electronically accessible medium comprises instructions that, when executed by an apparatus, cause one of the server nodes to transmit an internal communications message to the message server via the separate socket connection between the server node and the message server, and the message server to replicate and transmit the message to the other server nodes via the respective separate socket connections between the message server and the other server nodes.
